(19) United States
(12) Patent Application Publication
(10) Pub. No.: US 2008/0263829 A1
(43) Pub. Date: Oct. 30, 2008

(54) CUSTOMIZABLE GRIP AND METHOD FOR MAKING

(75) Inventor: Christopher S. Diasio, Jupiter, FL (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: Diasio, LLC, Jupiter, FL (US)

(21) Appl. No.: 11/740,552

(22) Filed: Apr. 26, 2007

(51) Int. Cl. B25G 1/00; B29C 67/20

(52) U.S. Cl. 16/421; 264/293

(57) ABSTRACT

This disclosure includes a customized grip handle, including a handle and a formable, polymeric compound layer, having a water-soluble polymeric resin, water, and a gellant. The polymeric compound layer may have an imprint of a hand, which is set upon removal of moisture. A method of making a customized grip handle and a grip kit are also disclosed. The grip kit may include a polymeric compound layer and a self-fusing tape with which a user may cover the handle base and place the compound on it and form a hand imprint.

### BACKGROUND

This disclosure generally concerns improved moldable grips and methods for making them. In particular, it concerns grips which are imprinted with a polymeric compound in a wet state and then moisture is removed to rigidify into that imprinted state.

It has long been recognized that the act of gripping an object can be uncomfortable, especially if repetitive, extensive or tight gripping is desired. After extended periods of gripping, a user may be susceptible to fatigue resulting from maintaining a constant or firm grip (or both) on the object. A grip which allows a user to exert a steady, dependable grip may provide more comfort and better results, e.g., on a racket, or even prevent minor or major accidents (e.g., on a hammer or a steering wheel).

Additionally, in cases where vibration may occur such as, but not limited to, grips on handlebars, steering wheels or motorized tools (e.g., drills, saws, etc.) maintaining a grip that maximizes contact with the object being gripped will not only increase comfort and safety levels, but may additionally reduce fatigue associated with vibration during gripping.

Grip additions and customizations are known. For example, U.S. Pat. No. 4,174,109 to Gaiser describes a cushioning hand grip sleeve which is placed over a tool handle. The sleeve is made of compressible foam which does not retain significant amounts of moisture during and between uses. The sleeve is not customized.

U.S. Pat. No. 4,785,495 to Dellis concerns a custom molded grip, including a heat formable plastic layer. The heat formable plastic layer is moldable and remoldable when heated to hair dryer temperatures. Of note, in settings where a grip is exposed to heat, such as on a steering wheel on a car on a hot day, the grip may not hold its shape and need to be remolded. Such remolding may neither be convenient, nor quickly accomplished, depending on temperature of the moldable layer and how quickly cooling can be effected.

U.S. Pat. No. 5,511,445 to Hildebrandt describes a disposable, reusable hand grip made of a layer of bands. The hand grip is not customizable.

U.S. Pat. No. 5,692,265 to Dalury describes an ergonometric handle shaped to accommodate the natural curvature of the hand. The handle is not customizable.

U.S. Pat. No. 5,281,288 to Murray consists of an adhesively double-sided tape for securing a grip to a handle.

U.S. Pat. No. 6,148,483 to DeGraff concerns a light curable, moldable handle grip. To form a custom grip, adhesive is applied, buffer material added, additional adhesive and wrap material are applied, and then an imprint of a user's hand is taken. Light is then applied to cure the grip. Though customizable, this grip requires special equipment or proficiency with multiple steps involved in taking an imprint or both.

U.S. Pat. No. 5,155,878 to Dellis concerns a two-layer grip where the inner layer is thermoplastic and an outer layer is adherent and non-thermoplastic. While this grip solves some of the problem associated with U.S. Pat. No. 4,785,795, a user must still heat the inner layer to an appropriate temperature with boiling water to form the grip. Additionally, the outer layer, which is formed with sufficient thickness to allow gripping during the forming stage and to absorb vibrations, is not customized.

U.S. Patent Application No. 2004/0050205 to Putnum entails a hand grip having a cover layer, a base layer, a gel layer and fastening elements. It is not customizable.

There exists a need for improved, customizable grips which are heat-tolerant, have inherent cushioning, attenuate vibration and are easily made by a non-technical user.

### SUMMARY

In certain embodiments, a grip handle for use in a customized grip is disclosed, including a handle and a formable, polymeric compound layer, which includes a water-soluble polymeric resin, water, and a gellant. The polymeric compound layer has an imprint of a hand, which is set in a more rigid state upon removal of moisture.

In other embodiments, a method of making a customized grip handle is provided, which includes placing a wet, polymer modeling compound on a handle base, applying pressure to the polymer modeling compound to shape the material to an imprinted configuration, and allowing the polymer modeling compound to lose its moisture. Optional steps, including providing an intermediate layer to the handle prior to placing the polymer modeling compound, are also disclosed.

In another embodiment, a grip kit is provided, which includes a formable, polymeric compound having a water-soluble polymeric resin, water and a gellant and a self-fusing tape. A user can use the tape to cover a handle base and place the compound on it to form a hand imprint in the compound.

### BRIEF DESCRIPTION OF THE DRAWINGS

FIG. 1 is a side view schematic illustration of elements in an embodiment of a customized grip.

FIG. 2 is a side, partial cut-away perspective view of the embodiment of the grip shown in FIG. 1.

FIG. 3 is a cross-section of the embodiment shown in FIG. 2, taken through line 3-3.

FIG. 4 is a front perspective view of grip kit for making a customized grip.

FIG. 5 is a schematic of the steps for making the embodiment illustrated in FIG. 2.

### DETAILED DESCRIPTION OF THE EMBODIMENTS

For the purposes of promoting an understanding of the principles of the disclosure, reference will now be made to the embodiment illustrated in the drawings and specific language will be used to describe the same. It will nevertheless be understood that no limitation of the scope of the claims is thereby intended, such alterations and further modifications in the illustrated device, and such further applications of the principles of the disclosure as illustrated therein being contemplated as would normally occur to one skilled in the art to which the disclosure relates.

Referring generally to the FIGs, there is shown an embodiment of a customizable grip handle 10. As shown in FIG. 2, grip handle 10 may include handle base 12, a formable, polymeric compound layer 14, an intermediate layer 18, and a cover 20. The context of the discussion that follows is that of a grip customized to a specific user's hand, although it will be seen that the apparatus and methods disclosed could be used in other contexts as well; for example, grips might be semi-customized for a particular group, e.g. women, elderly, children, people missing a digit or grips might be semi-customized according to a particular activity, such as, but not limited to, golf, driving, or cleaning.

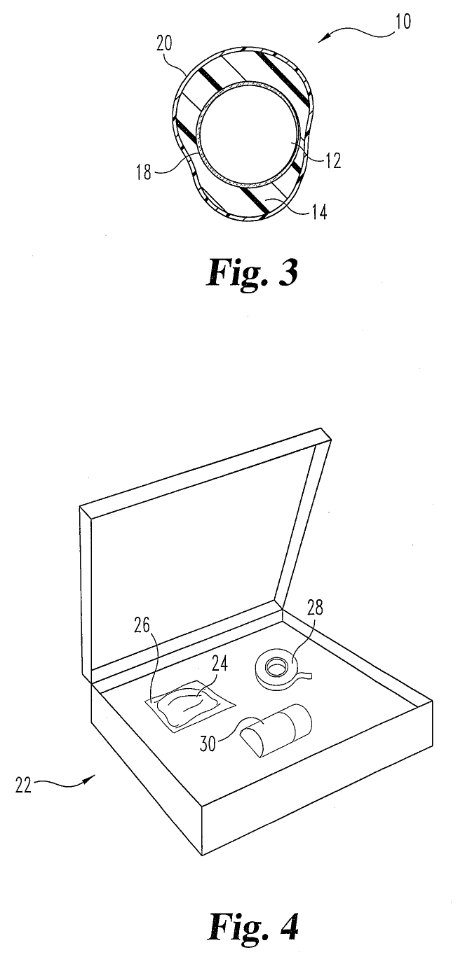

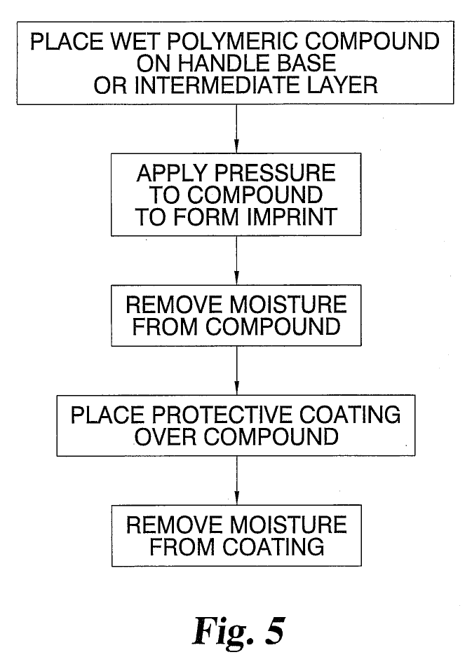

Grip handle 10, in the illustrated embodiment, includes handle base 12. As shown in FIGS. 2 and 3, base 12 is generally shaped to accommodate a person's hand grip. For example, base 12 may be generally cylindrical or tubular and have a uniform cross-sectional radius. As illustrated, base 12 may be in the form of a protrusion, such as a knob, shaft or shelf. Alternatively, base 12 might be a portion of a larger object in which a void for encapsulating a hand has been placed. Handle base 12 may have a rectangular, square, or otherwise-shaped cross-section. Its cross-sectional radius could be uniform throughout or variable. Base 12 may be hollow or solid. The term handle base 12 is intended to be broadly construed as that part of an object which is held in the hand when the object is used or moved. As a non-limiting example, handle base 12 could be that of a hammer, paintbrush or paint roller, garden tool, fishing rod, golf club, ski pole, sports racket, firearm, shift lever, motorcycle or bicycle handlebar, oar, weightlifting equipment, bucket handle, or cooking pot handle. Any tool, vessel or instrument which is grasped, in any fashion, may be used as a base for the present grip handle.

Formable, polymeric compound layer 14 includes a polymeric modeling compound. In the illustrated embodiment, layer 14 is made entirely from a polymeric modeling compound, such as that found in Crayola® Model Magic® products and disclosed in U.S. Pat. Nos. 5,364,892; 5,171,766; 5,506,280; and 5,498,645, which are herein incorporated by reference in their entirety. The polymeric modeling compound may account for all of polymeric compound layer 14, a majority or it or only a portion. For example, in some embodiments, it may be desirable to have polymeric modeling compound only placed at the finger tip imprint area, the palm imprint area, a portion of these or in other key areas found in a hand imprint. In such cases, additional materials may form some or most of formable, polymeric compound layer 14. So long as some portion of layer 14 is customizable using a polymeric modeling compound, it is considered to fall within the definition of layer 14.

Polymeric modeling compound may be made from about 40 to about 60% water, from about 4 to about 15% total polymeric resin, from about 0.5 to about 30% filler, from about 0.05 to about 2% gellant, and up to 20% of a humectant. Percentages expressed in this application are expressed as percentages by weight unless otherwise indicated.

One formulation of the compound comprises from about 43% to 49% water, from about 10% to about 14% total polymeric resin, from about 24% to about 26% filler, from about 0.05% to about 0.2% gellant; from about 1% to about 2% defoamer; from about 0% to about 2% wetting agent; from about 0% to about 1% buffering agent; from about 5% to about 15% humectant; from about 0.5% to about 1% fragrance; from about 0% to about 5% colorant; and from about 0.15% to about 75% preservative.

A variety of polar polymeric resins may be used in the modeling compounds. Polymeric resins suitable for use in the modeling compounds of the present invention include, for example, water-soluble resins such as poly(vinyl alcohol), alginate resins, polysaccharide gums, cellulose gums, starches, guars, agars, gum arabic, acrylic acid, Gellan gum, CARBOPOL resins, polyvinylpyrrolidone resins, and copolymers of vinyl acetate and methacrylates or acrylates which are then subsequently fully hydrolyzed to yield copolymers of vinyl alcohol and methacrylic or acrylic acid. Examples of the latter resins include ELVANOL 93-01, ELVANOL 75-15, and ELVANOL 85-82. All of these resins are water soluble either with or without agitation. In general, polymeric resins containing polar groups, such as alcohol, ether, ester, amide, amine, or siloxane groups, may be used as resins in the modeling compounds. Non-water-soluble resins containing polar groups may be used.

The polar polymeric resins may be present in the modeling compound in an amount of from about 4% to about 15% by weight of the composition. They may be present the modeling compound from about 8% to about 12% by weight of the composition.

One class of polymeric resins is poly(vinyl alcohol), a cream-colored powder which is soluble in water and insoluble in most organic solvents. It is made by the hydrolysis of poly(vinyl acetate) and contains from about 1% to about 22% acetyl groups. Poly(vinyl alcohol) may be partially or fully hydrolyzed. It varies in molecular weight according to the length of the resin chain.

Medium molecular weight (85,000-146,000), partially hydrolyzed (87-89%) poly(vinyl alcohol) or a near fully hydrolyzed (96.5-97.5%) low/medium molecular weight (31,000-146,000) poly(vinyl alcohol) have been found to function well in the present disclosure. Poly(vinyl alcohol) resins sold under the tradenames AIRVOL 523 and AIRVOL WS42 by Air Products & Chemicals, Inc. and ELVANOL 52-22 by E. I. duPont de Nemours and Company generally fall within these above-mentioned parameters.

A lower molecular weight, partially hydrolyzed poly(vinyl alcohol) such as AIRVOL 203 or AIRVOL 205 may be used to enhance the retained compressibility in the molded state. The average molecular weights of AIRVOL 203 and AIRVOL 205 are each about 31,000-50,000. Alternatively, polyvinyl alcohols with lower levels of hydrolysis or copolymers of vinyl alcohol and methacrylic acid or acrylic acid may be used to enhance molded state retained compressibility.

Other disclosed polar polymeric resins useful in the present disclosure are sold under the tradenames ELVANOL 93-01, ELVANOL 75-15, and ELVANOL 85-82, available from E.I. du Pont de Nemours and Company. These resins are derived from a copolymer of vinyl acetate and an acrylate or methacrylate comonomer. The acrylate or methacrylate comonomer is believed to be present in an amount from about 5 wt. percent to about 50 wt. percent. These resins are fully hydrolyzed to yield copolymers comprising vinyl alcohol groups and methacrylic acid or acrylic acid groups. The acid groups can then further react to form internal esters (lactones).

It is believed that these resins are more internally plasticized than are conventional poly(vinyl alcohol) resins. In addition, these grades of ELVANOL also are more stable at high pH than are standard polyvinyl alcohols. These resins may be used in addition to, or in place of, poly(vinyl alcohol) in the modeling compound. A small amount of a conventional poly(vinyl alcohol), such as AIRVOL 125, may be used with the ELVANOL to tailor the rigidity of the modeling compound.

Examples of polysaccharide gums for use as polymeric resins in the modeling compound include Gellan gum, KELSET, KELTOSE, KELZAN, and KELCOGEL, available from Kelco division of Merck, Inc., San Diego, Calif. Suitable cellulose gums include, for example, carboxymethylcellulose gums, such as AQUALON cellulose gum, available from AQUALON Co., Wilmington, Del., and hydroxyethylcellulose gums, such as that sold under the trademark CELLOCIZE QP40, available from Union Carbide Chemicals & Plastics Co., Inc., Danbury, Conn. These resins may be used in conjunction with poly(vinyl alcohol) in the modeling compound, or without poly(vinyl alcohol).

Suitable polyvinylpyrrolidones include PVP K-15 and K-60, available from GAF Chemicals Corp., Wayne, N.J. Another suitable class of resins is the CARBOPOL resins available from B.F. Goodrich Co., Cleveland, Ohio. CARBOPOL resins are crosslinked copolymers of acrylic acid. For example, CARBOPOL 961 may be used in the modeling compound. These resins may also be used in conjunction with poly(vinyl alcohol) in the modeling compound. In addition, CARBOPOL resins allow for pH-sensitive thickening of the modeling compound. As the pH of the compound is increased over a range of about 7½ to about 9, the acrylic acid in the polymeric resin is neutralized, and becomes ionic. This may result in a stiffer, less tacky modeling compound.

In addition, a number of other materials have been found suitable for use in the modeling compound in conjunction with poly(vinyl alcohol). For example, starches, such as wheat, corn, and potato starch may be used. In addition, other plant sources, such as guar, agars, and gum arabic may be used. Examples of such materials include SUPERCOL guar gum, available from Aqualon Co., Wilmington, Del., and AMAIZO 710 corn starch, available from American Maize Products Co., Hammond, Ind.

Further, non-water-soluble resins, such as silicone polymers, may be used with poly(vinyl alcohol) as the polar resin in the modeling compound. An example of such a silicone polymer is DOW CORNING Q2-3233.

A gellant, such as a water soluble borate salt, in an amount of about 0.05 to about 2 weight percent, may be used to substantially gel the resin, eliminate stickiness, and impart wet ductility to the resulting compound. Most water soluble borate salts are acceptable, though sodium tetraborate also acts as a buffer to maintain the pH of the system. Other workable gellants include, but are not limited to, resorcinol, catechol, gallic acid, 2-4-dihydroxy benzoic acid and congo red dye. The gellant used in the modeling compound may be in the range of from about 0.15% to about 0.30% by weight.

A filler, such as would bond to create a matrix with the gelled polar polymer resin, may also be present in the modeling compound. The filler may help enable the water to evaporate from the modeling compound in the molded state such that shrinkage is minimal. Workable fillers, in the amount of 0.5 to 30 weight percent, include hollow composite microspheres, inert talcs, calcium carbonate, mica, clay or ceramic particles and combinations thereof. One embodiment of the modeling compound composition has a concentration of filler in an amount of from about 25% to about 26% by weight.

Hollow composite microspheres are an example of a low cost filler. They are lightweight (having a density of about 0.13 g/cc) and lower the density of the modeling compound. The hollow composite microsphere filler incorporated into the modeling compound may be helpful in preventing the molded object or sculpture from shrinking upon drying While the weight percent of water in the present invention is high (45 to 65%), the actual partial volume of water is relatively low due to the relatively high density of water (1.0 g/cc) and low density of the microspheres. Consequently, the hollow microspheres may constitute a majority of the volume of the compound. The polar polymeric resin and the microspheres may bind together to help give a sufficient structural integrity for molding, allowing the compound to retain a large percentage of its total volume when moisture evaporates (in its molded state).

One filler consists essentially of hollow composite microspheres of about 50 micron diameter and having a wettable particulate coating. Microspheres with a larger diameter are workable but may give the compound a grainy texture. Microspheres with a smaller diameter may result in a heavier compound but result in a smoother texture. Thus, the choice of particle size is determined by the desired end properties.

A microsphere coating may facilitate the wetting of the microspheres by the liquid ingredients of the compound. The coating may also contribute to the smooth feel and inhibits stickiness in the final product, thereby allowing easy manipulation. The preferred coating is calcium carbonate. Other coatings include talc, alumina trihydrate, and titanium dioxide, as well as functional components such as pigments and dyes.

One preferred coated microsphere is sold under the tradename DUALITE™ M6001AE by Pierce & Stevens. M6001AE is an ultra-low density, resilient, polymeric microsphere coated with calcium carbonate. It is a lightweight filler that reduces density of the compound and occupies the volume not attributable to water and resin. The resilient polymeric microspheres are shear stable and impact resistant, thus remaining intact under formulation conditions. Other hollow composite microsphere fillers useful in the composition of the invention have densities ranging from 0.10 to 0.75 g/cc, and include the wettable particulate coatings discussed above.

Other workable microspheres are available in various sizes and densities. Ceramic microspheres range in diameter from 15 to 40 microns and have a density of about 0.7 g/cc. Ceramic microspheres may give the compound a grainier texture and a brownish coloring. Silica alumina alloy microspheres range in diameter from 1 to 100 microns and have densities ranging from 2.1 to 2.5 g/cc, depending upon the wall thickness. Plastic microspheres made from a variety of materials are available in sizes ranging from 1 to 1000 micron diameter and densities ranging from 0.13 to 0.95 g/cc. Any of these materials, or combinations of such materials, may be employed for the purpose of achieving particular combinations of properties.

In addition to microspheres, other fillers may be used with the modeling compound. For example, polymeric fillers, having plate-like, fibrous, or other shapes may be used, as may nonpolymeric fillers. These materials may replace the microspheres in whole or in part. For example, KEVLAR an aramid pulp fiber available from E.I. du Pont de Nemours & Co., Wilmington, Del., and KAYOCEL a family of cellulose fibers available from American Fillers and Abrasives, Inc., Bangor, Mich., may be used in the modeling compounds of the present invention. Alternatively, compounds such as mica, silicates, and clays may be used. Examples of suitable mica are those available from KMG Minerals, Inc., Kings Mountain, N.C. When used, the mica is preferably 325 mesh mica. Suitable silicates include sodium potassium aluminum silicate, available from Nord Perlite, Dayton, Ohio. Suitable clays include, for example, clays available from Southern Clay Products, Gonzales, Tex., under the names LAPONITE RDS and LAPOMER 40, and POLARGEL T, available from American Colloid Co., Arlington Heights, Ill. Although clay may be used as a filler in the modeling compounds of the present invention, the modeling compounds of the present invention preferably are formulated without clay. Wheat flour, available from ConAgra, Inc., Omaha, Nebr., may also be used as a filler, and may further act as a water-soluble polymeric resin.

Non-fibrous fillers may have a particle size ranging up to about 150 microns. Preferably, the fillers have a particle size less than about 50 microns. Fibrous fillers may have a size of about 30 microns to 0.5 mm depending on the desired texture of the finished product.

Waxes may also be used in the modeling compound in conjunction with other fillers. Any compatible natural or synthetic wax may be used, including water-soluble waxes and non-water-soluble waxes. Non-water-soluble waxes are immiscible with water and are especially suitable as fillers. Waxes, defined as those waxes that are solid at room temperature, can be powdered to add to the other solid ingredients during the preparation of the modeling compound. Preferably, DUALITE microspheres are used in conjunction with a wax when a wax is used. When used, the wax preferably has a molecular weight ranging from about 150 to about 4,000. Examples of suitable waxes include sodium stearate, such as that available from Witco Oleochemicals/Surfactants Group, Houston, Tex.; AQUAWAX 114, a micronized wax available from Micro Powders, Inc., Tarrytown, N.Y.; DOW CORNING 290, available from Dow Corning, and those CARBOWAX polyethylene glycols available from Union Carbide that are solid at room temperature. Carbowaxes and other water-soluble, low molecular weight waxes that are liquid at room temperature may properly be classified as humectants.

A humectant may also be added, to help plasticize the polymer polar resin, especially a poly(vinyl alcohol). Without the humectant, the disclosed modeling compound may be more brittle and the use of a humectant improves the workability of the disclosed modeling compound. There is a wide variety of workable humectant materials. Some useful humectants include triglycerol and glycerin. Alternative humectants are propylene glycols, poly(ethylene glycols) (i.e. Carbowax 200) and diethylene glycol. The humectant may be present in an amount of from about 0 to about 20% by weight, or about 5% to about 15% by weight. Where the polymeric resin is a poly(vinyl alcohol) having a level of hydrolysis of from about 40% to about 80%, the humectant may be present in an amount up to about 15% by weight.

One composition of the modeling compound disclosed by the present invention incorporates additional optional components: a defoamer; a wetting agent or dispersant; a preservative; a colorant; and a buffer.

A defoamer is used to eliminate air bubbles upon mixing of the components, and such additives are readily available from numerous sources. The amount of defoamer is not critical, though such materials are typically used in amounts of from about 1 to 2% by weight. Balab Bubblebreaker 748, an aliphatic oil and surfactant mixture, or any other of the commercially available defoamers are equally suitable.

The wetting agent promotes dispersion of the microspheres and of any particulate colorant during the mixing of the disclosed modeling compound, and such materials are well known. One preferred wetting agent is sold under the tradename NOPCOSPERSE 44 by Henkel, a nonionic polyelectrolyte. A wetting agent may be included in a weight percent range of from about 0 to about 2%.

An additive that increases shelf-life is a preservative, and a wide variety of such materials is available commercially. One preferred preservative is KATHON LX1.5, a 1.5% solution of isothiazolines. The preferred weight percent of preservative is from about 0.15 to about 0.75%.

A buffer may also be added to raise the pH in some formulations. When the pH is below 7.0, the polar polymeric resin may not gel properly. If boric acid is used as the gellant, it tends to lower the pH and creates the need for a buffer. Formulations using low molecular weight, partially hydrolyzed poly(vinyl alcohol) resins are acidic and require a buffer. However, one appropriate buffer is sodium tetraborate, which is also a gellant. Another buffering system contains tris(hydroxymethyl)aminomethane and HCl as the buffering agents. The buffer would therefore comprise tris(hydroxymethyl)aminomethane, 0.1M HCl, and water. Alternative buffering agents include 2-amino-2-methyl-1-propanol, such as AMP 95, sold by IMC Chemical Group, Inc., and sodium bicarbonate. Buffer, when used, is generally included in a range from about 0 to about 1% by weight of the total modeling compound.

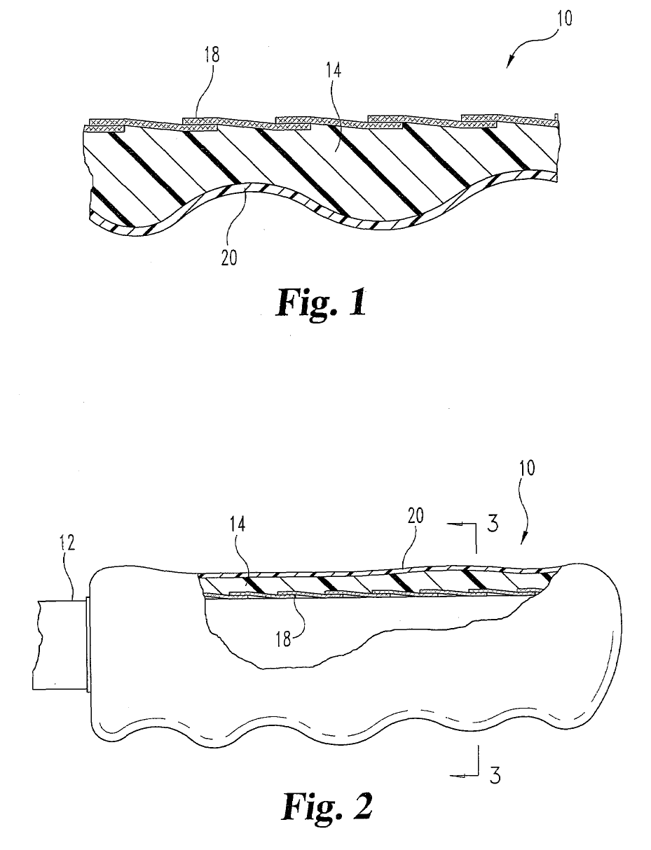

Grip handle 10 may optionally have intermediate layer 18. When present, layer 18 is applied such that it is readily releasable from handle base 12, e.g. it does not adhere to base 12 or otherwise engage base 12 is a non-releasable manner. As shown in FIGS. 1-3, intermediate layer 18 is between handle base 12 and compound layer 14. Intermediate layer 18 may provide a better surface for attaching layer 14 to than base handle 12. Layer 18 may also protect handle base 12, both when layer 14 has been added and after layer 14 has been removed.

As illustrated, intermediate layer 18 is a releasable layer. It is formed from a material which self-fuses or shrink-fits or otherwise readily remains placed on handle base 12 without adhering to base 12. This may allow for easy removal of intermediate layer 18, compound layer 14 and cover 20 (if present) without damaging the underlying structure of handle base 12 or leaving behind adherent residue. In the illustrated embodiment, intermediate layer 18 is made from a self-fusing tape, such as a silicone rubber tape. Alternatively, layer 18 could be a heat-shrinkable tube or wrap, thereby also allowing for protection of the handle base 12 while also providing a surface to which compound layer 14 may adhere or remain in contact.

Grip 10 may optionally have protective cover 20. If present, cover 20 is generally thin, such that it readily conforms to the shape of compound layer 14. Cover 20 may be made from a protective coating material, such as a neoprene or silicon coating. As shown in the illustrated embodiment, cover 20 is applied in a liquid form. Cover 20 may be moisture-resistant, a natural anti-bacterial/fungicide or have an anti-bacterial/fungicide added, and provide for odor control. Additionally, cover 20 may also provide a uniform, stable gripping surface. If a liquid form cover 20 is used, it may be sprayed on, painted on or otherwise applied. Additionally, cover 20 may be applied in a form other than a liquid, such as tape, or other thin solid material. Cover 20 generally overlays the grip, thereby protecting it from abrasion, moisture, wear, and other degrading forces.

FIG. 4 shows an embodiment of a grip kit 22. Grip kit 22, as illustrated, contains material for forming a compound layer 24, material for forming an intermediate layer 28 and material for forming a cover 30. As illustrated, compound-forming material 24 may be provided in a general, amorphous lump. Alternatively, material 24 could be provided in other forms, such as in a roll, within a tube or as a pre-formed mass, for example a square, sphere, or other shape or in a configuration that is already indented and shaped to somewhat accommodate a user's hand for imprinting.

Compound-forming material 24 includes a water-soluble polymeric resin, water and a gellant. It optionally contains a filler, humectant, and other ingredients, such as those described above with respect to formable, polymeric compound 14. In the illustrated embodiment, compound-forming material 24 is made entirely from a polymeric modeling compound, such as that found in Crayola® Model Magic® products and disclosed in U.S. Pat. Nos. 5,364,892; 5,171,766; 5,506,280; and 5,498,645, which are herein incorporated by reference in their entirety. The compound-forming material 24 may be entirely composed of a polymeric modeling compound, or it may be a mixture of a polymeric modeling compound and additional compounds or additional compounds may be provided separately.

Compound-forming material 24 may be contained within a moisture-proof barrier 26 to inhibit evaporation prior to use. As illustrated in FIG. 4, this moisture-proof barrier 26 may take the form of a plastic bag. This depiction of moisture proof barrier should not be seen as limiting; moisture-proof barrier could be in many other forms, including, but not limited to, a vacuum-sealed kit, a sheet of moisture-proof wrapping adjacent to material 24, or a tube or other container.

Intermediate layer-forming material 28 may be in the form of a self-fusing tape, as illustrated in FIG. 4. Material 28 is a material which self-fuses or shrink-fits or otherwise has properties which allow it to readily remain placed on handle base 12 without adhering to base 12. In the illustrated embodiment, intermediate layer 18 is made from a self-fusing tape, such as a silicone rubber tape. Alternatively, material 28 could be a heat-shrinkable tube or wrap or other material which allows for placement without affecting the underlying base 12. Material 28 could be provided in a liquid, gel, or other solid form, for example as strips, rather than as a roll of tape.

Grip kit 22 optionally provides a material for forming a cover 30. As illustrated, material 30 is provided in a container, and more specifically in a spray can. Material 30 could be provided in other ways, for example, as a liquid in an alternate form, such as in a tube, or in a container with a liquid applicator. Material 30 could also be provided as a solid, such as thin strips or a thin sheet. Material 30 provides a protective coating and may be in the form of a neoprene or silicon liquid. Material 30 may also be moisture-resistant, a natural anti-bacterial/fungicide or have an anti-bacterial/fungicide added, and provide for odor control. Additionally, material 30 may also provide a uniform, stable gripping surface. Material 30 generally is applied as an overlay for the grip, thereby protecting it from abrasion, moisture, wear, and other degrading forces.

Alternatively, grip kit could be provided as a non-adherent intermediate material, such as material 28, and include any customizable grip material. In this way, grip kit would comprise a non-adherent intermediate material, such as a self-fusing tape or a heat-shrinkable tube or sheet that would be associated with a customizable grip forming material that allows a user to cover a handle base with the intermediate material and then to form a hand imprint in the customizable grip material. This kit would enable a user to form a customized grip that could later be easily released from the grip handle if the customizable grip were no longer needed.

The customized grip disclosed herein may be applied in at least the following manner. Optionally, an intermediate layer 18 is applied to grip handle 12. Intermediate layer 18 is placed on grip handle 12 in such a way that it is secure. For example, if intermediate layer 18 is a self-fusing tape, the tape may be wrapped around handle 12. In this case, the tape may be overlapped with the previous layer as it is wound around handle 12. Alternatively, if a heat-shrinkable tube or sheet were provided as layer 18, it would be placed on handle 12 and then heated until layer 18 snuggly enveloped handle 12. Next polymer compound 14 is laid on top of intermediate layer 18 (if used) or handle 12. Compound 14 may be wrapped around the entire perimeter of handle 12 or applied in only desired areas. Compound 14 should completely cover any areas where a customized grip is desired. If wrapped entirely around handle 12, the seam at which compound 14 engages itself may be smoothed to allow for minimal disruption in the imprint. Compound 14 may then be gripped (and pressure applied) by a user's hand in the position the user desires a customized grip to be formed. A user may wish to wear gloves at this point, particularly if the handle 10 is generally gripped by a user wearing gloves. Alternatively, if any additional objects are normally within the user's hand or covering the user's hand, the user may choose to form the imprint with those objects oriented as they would be when user grip handle 12. Once the imprint is made, the grip (and associated pressure) may be released. Areas may be smoothed out or otherwise additionally shaped, if desired. Excess moisture is then removed from layer 14 allowing the layer to set the imprint of the hand in a more rigid state. Moisture may be removed by exposing layer 14 to air and allowing moisture to evaporate. While relative humidity and other factors will influence how quickly this method allows moisture to evaporate, layer 14 will generally dry within 24 hours if being air-dried. Of course, moisture could be removed in alternate ways, including but not limited to, exposure to a vacuum, an evaporation chamber, or the sun.

Once layer 14 has dried, optional cover 20 may be applied. If provided in a liquid form, cover 20 may be applied as a single or multiple layers. If provided as neoprene or silicone, cover 20 will also set upon removal of moisture. As with layer 14 above, moisture may be removed by exposing cover 20 to air and allowing it to dry. While relative humidity and other factors will influence how quickly this method allows moisture to evaporate, cover 20 will generally dry within 24 hours if being air-dried. Of course, moisture could be removed in alternate ways, including but not limited to, exposure to a vacuum, an evaporation chamber, or the sun. If multiple layers of cover 20 are to be applied, it is recommended that some removal of moisture be allowed between the application of layers. Generally, enough moisture can be removed if allowed to air-dry for four hours between application of layers.

While the disclosure has been illustrated and described in detail in the drawings and foregoing description, the same is to be considered as illustrative and not restrictive in character, it being understood that only the preferred embodiment has been shown and described and that all changes and modifications that come within the spirit of the disclosure are desired to be protected.

1. A grip kit comprising:
a formable, polymeric compound including a water-soluble polymeric resin, water and a gellant; and
a self-fusing tape associated with said compound wherein a user can use said tape to cover a handle base for placement of said compound thereon to form a hand imprint in said placed compound.

2. The grip kit of claim 1, in which said polymeric compound is contained within a moisture proof barrier to inhibit evaporation prior to use.

3. The grip kit of claim 2, wherein said polymeric compound includes:
a) 4-15% polymeric resin,
b) 40-60% water,
c) 0.5-30% filler; and
d) 0.05-2% gellant.

4. The grip kit of claim 3, wherein said polymeric compound further includes up to 20% of a humectant.

5. The grip kit of claim 4, wherein said self-fusing tape is a silicone tape.

6. The grip kit of claim 5, further comprising:
a protective coating, associated with said compound wherein the user can use said coating to cover said placed compound.

7. The grip kit of claim 6, wherein said protective coating is a neoprene coating or a silicone-based coating.

8. The grip kit of claim 7, wherein said protective coating compound is a neoprene coating.

9. A grip handle comprising:
a handle; and
a formable, polymeric compound layer, including a water-soluble polymeric resin, water, and a gellant;
said polymeric compound layer having an imprint of a hand;
whereby said compound sets the imprint of a hand in a more rigid state upon removal of moisture.

10. The grip of claim 9 wherein said polymeric compound layer includes:
a) 4-15% polymeric resin
b) 40-60% water
c) 0.5-30% filler; and
d) 0.05-2% gellant

11. The grip of claim 10 wherein said polymeric resin is selected from the group consisting of poly (vinyl alcohol), copolymers of vinyl alcohol and methacrylic acid, and copolymers of vinyl alcohol and acrylic acid.

12. The grip of claim 11 wherein said polymeric resin is poly (vinyl alcohol).

13. The grip of claim 12 wherein said poly (vinyl alcohol) is only partially hydrolyzed.

14. The grip of claim 11, wherein said polymeric resin is a copolymer of vinyl alcohol and methacrylic acid or a copolymer of vinyl alcohol and acrylic acid

15. The grip of claim 13 wherein said polymeric compound layer further includes up to 20% of a humectant.

16. The grip of claim 14 wherein said polymer modeling compound layer further includes up to 20% of a humectant.

17. A method of forming a grip on a handle comprising the steps of:
placing a wet, polymer modeling compound including a polymeric resin, a gellant and water on a handle base,
applying pressure to said polymer modeling compound to shape the material to an imprinted configuration; and
allowing said polymer modeling compound to lose its moisture.

18. The method of claim 17, further comprising the step of forming a protective coating over said air-dried polymeric compound.

19. The method of claim 18, wherein said coating is formed using a neoprene coating.

20. The method of claim 17, further comprising the step of applying an intermediate layer to said handle prior to placing said polymer modeling compound.

21. The method of claim 20, wherein said intermediate layer is a self-fusing silicone tape.

22. A grip made in accordance with the process of claim 21.
